(19) United States
(12) Patent Application Publication
(10) Pub. No.: US 2014/0192011 A1
(43) Pub. Date: Jul. 10, 2014

(54) TOUCH-INPUT DETECTION DEVICE, TOUCH-SCREEN HAVING THE SAME, AND METHOD OF DETECTING A TOUCH-INPUT

(71) Applicant: Samsung Display Co., Ltd., Yongin-City (KR)

(72) Inventor: Kyung-Youl Min, Yongin-City (KR)

(73) Assignee: Samsung Display Co., Ltd., Yongin-City (KR)

(21) Appl. No.: 14/024,446

(22) Filed: Sep. 11, 2013

(30) Foreign Application Priority Data
Jan. 4, 2013 (KR) 10-2013-0000837

(51) Int. Cl. G06F 3/044

(52) U.S. Cl. CPC G06F 3/044
USPC 345/174

(57) ABSTRACT

A touch-input detection device is disclosed. In one aspect, the device includes a touch panel having first sensing electrodes and second sensing electrodes. The device additionally includes a sensing signal driver configured to generate a sensing signal and to apply the sensing signal to a charge pump unit and the first sensing electrodes. The charge pump unit is configured to generate an output voltage based on the sensing signal and an output signal from the second sensing electrodes. The device further includes a control unit configured to determine whether or not a touch input has been applied on the touch panel based on the output voltage.

### CROSS-REFERENCE TO RELATED APPLICATIONS

This application claims priority under 35 USC §119 to Korean Patent Applications No. 10-2013-0000837, filed on Jan. 4, 2013 in the Korean Intellectual Property Office (KIPO), the contents of which are incorporated herein in its entirety by reference.

### BACKGROUND

1. Field

The disclosed technology relates generally to touch-input detection devices and techniques, and more particularly to a touch input detection device configured to detect a touch input, a touch screen having the touch input detection device, and a method of detecting a touch input.

2. Description of the Related Technology

Electronic devices, especially mobile electronic devices, are increasingly manufactured in smaller form factors. With this trend, touch screens are increasingly used as input/output (I/O) devices in electronic devices. That is, the touch screens function as an output device by outputting images while also functioning as an input device by detecting a touch input (e.g., a touch input using fingers) made by users.

Generally, a touch screen includes a touch input detection device and a display. The touch input detection device detects touch inputs made by a user to determine a touch input position while the display outputs (i.e., displays) an image. Examples of displays include organic light emitting displays (OLED), liquid crystal displays (LCD), plasma display panels (PDP), and cathode ray tubes (CRT), among others.

A touch-input detection device generally includes a touch panel on which a touch-input can be made by a user, and a touch sensing unit that determines whether or not the touch-input has been made on the touch panel.

Depending on the way a touch-input is detected, a touch-input detection device may be classified as a capacitive-type touch-input detection device, a resistive film-type touch-input detection device, an infrared-type touch-input detection device, etc. Recently, capacitive type touch-input detection devices have been especially widely used because of their ability to detect multi-touch inputs.

Capacitive-type touch-input detection devices may be further classified as self-capacitive touch-input detection devices or mutual-capacitive touch-input detection devices. Self-capacitive touch-input detection devices generally include one sensor electrode, whereas mutual capacitive touch-input detection devices generally include a capacitive node corresponding to a pair of sensing electrodes between which a dielectric substance is placed. Thus, self-capacitive touch-input detection devices are configured to detect a touch-input based on a charge change at the sensor electrode, whereas mutual-capacitive touch-input detection devices are configured to detect a touch input based on a capacitance change at the capacitive node.

### SUMMARY OF CERTAIN INVENTIVE ASPECTS

Some example embodiments provide a touch input detection device capable of eliminating (i.e., reducing) parasitic components of a touch panel with a simple structure as well as determining whether a touch input has been made on the touch panel.

Some example embodiments provide a touch screen having the touch input detection device capable of eliminating (i.e., reducing) parasitic components of a touch panel with a simple structure as well as determining whether a touch input has been made on the touch panel.

Some example embodiments provide a method of detecting a touch input capable of eliminating (i.e., reducing) a parasitic element of a touch panel with a simple structure as well as determining whether a touch input has been made on the touch panel.

In one aspect, a touch-input detection device includes a touch panel having first sensing electrodes and second sensing electrodes, a sensing signal driver configured to generate a sensing signal to be applied to a charge pump unit and the first sensing electrodes, the charge pump unit configured to generate an output voltage based on the sensing signal and an output signal that is output from the second sensing electrodes, and a control unit that determines whether or not a touch input has been made on the touch panel based on the output voltage.

In example embodiments, the touch-input detection device further includes an analog-to-digital converter that digitizes the output voltage to generate a digitized output voltage. In these embodiments, the control unit determines whether or not the touch input has been made on the touch panel based on the digitized output voltage.

In example embodiments, the sensing signal comprises a square wave.

In example embodiments, the control unit is configured to determine a touch input position on the touch panel based on the output voltage.

In example embodiments, the charge pump unit includes a first current generator that generates a first current that is based on the sensing signal, and a second current generator that generates a second current based on the output signal. In these embodiments, the output voltage may be changed by a difference between the first current and the second current.

In example embodiments, the charge pump unit further includes a capacitor that performs charge and discharge operations using the first current and the second current. In these embodiments, the output voltage may be changed as charges of the capacitor are changed by the difference between the first current and the second current.

In example embodiments, the first current generator may include a first current source and a first switch, the first switch being controlled by the sensing signal.

In example embodiments, the second current generator includes a second current source and a second switch, the second switch being controlled by the output signal.

In example embodiments, the control unit is configured to generate a control signal to be output to the second current generator. In these embodiments, the second current generator may control the second current based on the output signal and the control signal.

In example embodiments, the touch-input detection device further includes a control signal generator that generates a control signal to be output to the second current generator. Here, the second current generator may control the second current based on the output signal and the control signal.

In example embodiments, the control signal generator is configured to generate the control signal based on a digitized output voltage, the digitized output voltage being converted from the output voltage by an analog-to-digital converter.

In example embodiments, the touch-input detection device further includes a voltage comparator that outputs a comparison result signal by comparing the output voltage with a predetermined reference voltage. In these embodiments, the control signal generator may generate the control signal based on the comparison result signal.

In another aspect, a touch screen includes a display device and a touch-input detection device that detects a touch-input. The touch-input detection device includes a touch panel having first sensing electrodes and second sensing electrodes, a sensing signal driver configured to generate a sensing signal to be applied to a charge pump unit and the first sensing electrodes, the charge pump unit configured to generate an output voltage based on the sensing signal and an output signal that is output from the second sensing electrodes, and a control unit configured to determine whether or not the touch input has been made on the touch panel based on the output voltage.

In example embodiments, the charge pump unit includes a first current generator that generates a first current based on the sensing signal, and a second current generator that generates a second current based on the output signal. Here, the output voltage may be changed by a difference between the first current and the second current.

In another aspect, a method of detecting a touch input includes applying a sensing signal to first sensing electrodes in a touch panel and outputting an output signal from second sensing electrodes to a touch sensing unit, where the first sensing electrodes and the second sensing electrodes forming a plurality of capacitive nodes in the touch panel. The method additionally includes generating an output voltage based on a stored charge in a capacitor, where the stored charge results from a first current generated based on the sensing signal and a second current is generated based the output signal. The method further includes determining whether or not a touch-input has been made on the touch panel based on the output voltage.

In example embodiments, the sensing signal comprises a square wave.

In example embodiments, determining whether or not the touch-input has been made on the touch panel includes converting the output voltage into a digitized output voltage using an analog-to-digital converter.

In example embodiments, determining whether or not the touch-input has been made on the touch panel includes outputting a comparison result signal by comparing the output voltage against a predetermined reference voltage, and controlling the second current based on the comparison result signal.

In example embodiments, determining whether or not the touch input has been made on the touch panel includes controlling the second current based on a digitized output voltage, the digitized output voltage being converted from the output voltage by an analog-to-digital converter.

In example embodiments, determining whether or not the touch-input has been made on the touch panel includes determining a touch-input position on the touch panel based on the output voltage.

Therefore, a touch-input detection device according to example embodiments may eliminate (i.e., reduce) parasitic components of a touch panel by simply controlling currents generated in a charge pump unit (i.e., with a simple structure) because the touch-input detection device can detect a capacitance-change of the touch panel based on a change of an output voltage due to a difference between the currents generated in the charge pump unit. Thus, an operational-performance of a touch screen having the touch-input detection device may be improved.

In addition, a touch screen having the touch-input detection device according to example embodiments may have an improved operational performance because the touch-input detection device eliminates (i.e., reduces) parasitic components of a touch panel by simply controlling currents generated in a charge pump unit (i.e., with a simple structure).

Further, a method of detecting a touch-input according to example embodiments may eliminate (i.e., reduce) parasitic components of a touch panel by simply controlling currents generated in a charge pump unit because the method of detecting the touch-input can detect a capacitance-change of the touch panel based on a change of an output voltage due to a difference between the currents generated in the charge pump unit.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a touch screen according to example embodiments.

FIG. 2 is a three-dimensional view of a touch panel according to one embodiment.

FIG. 3 is a cross-sectional view of the touch panel of FIG. 2 according to one embodiment.

FIG. 4 is a block diagram illustrating a touch input detection device according to example embodiments.

FIG. 5 is a block diagram illustrating a touch input detection device according to one embodiment.

FIG. 6 is a block diagram illustrating a touch input detection device according to another embodiment.

FIG. 7 is a block diagram illustrating a touch input detection device according to another embodiment.

FIG. 8 is a block diagram illustrating a touch input detection device according to another embodiment.

FIG. 9 is a block diagram illustrating a touch input detection device according to another embodiment.

FIG. 10 is a block diagram illustrating a touch-input detection device according to another embodiment.

FIG. 11 is a flow chart illustrating a method of detecting a touch input according to example embodiments.

FIG. 12 is a block diagram illustrating an electronic device having a touch screen according to example embodiments.

### DETAILED DESCRIPTION OF CERTAIN INVENTIVE EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

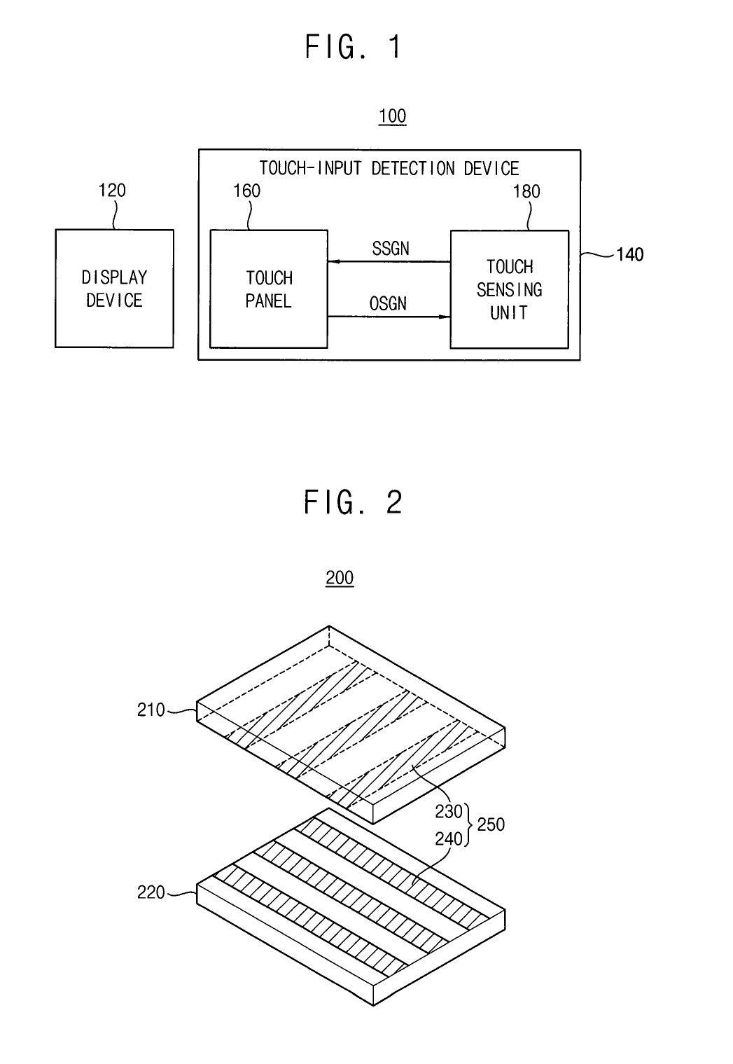

FIG. 1 is a block diagram illustrating a touch screen according to some embodiments.

In the illustrated embodiment of FIG. 1, the touch screen 100 includes a display device 120 and a touch-input detection device 140. In addition, the touch-input detection device 140 includes a touch panel 160 and a touch sensing unit 180. Here, the touch sensing unit 180 may be implemented as a circuit.

The display device 120 is an output device that outputs (i.e., displays) an image (e.g., text, figure, etc.). For example, an organic light emitting display (OLED) device, a liquid crystal display (LCD) device, a plasma display panel (PDP) device, a cathode ray tube (CRT) device, etc. may be used as the display device 120.

The touch-input detection device 140 is configured to detect touch inputs of users to determine touch-input positions.

The touch panel 160 is configured to generate an output signal OSGN based on a capacitance change at a capacitive node of the touch panel 160 (i.e., the capacitance-change occurs due to the touch-input of users) and a sensing signal SSGN output from the touch sensing unit 180, and may output the output signal OSGN to the touch sensing unit 180.

The touch sensing unit 180 is configured to determine whether or not the touch-input of users has been made on the touch panel 160, and is configured to calculate the touch-input position. The touch sensing unit 180 is additionally configured to generate the sensing signal SSGN to output the sensing signal SSGN to the touch panel 160. In addition, the touch sensing unit 180 is further configured to receive the output signal OSGN from the touch panel 160, determine whether or not the touch-input of users has been made on the touch panel 160, and calculate the touch-input position. In example embodiments, the touch sensing unit 180 determines whether or not the touch-input of users has been made on the touch panel 160, and calculates the touch-input position by comparing the sensing signal SSGN with the output signal OSGN.

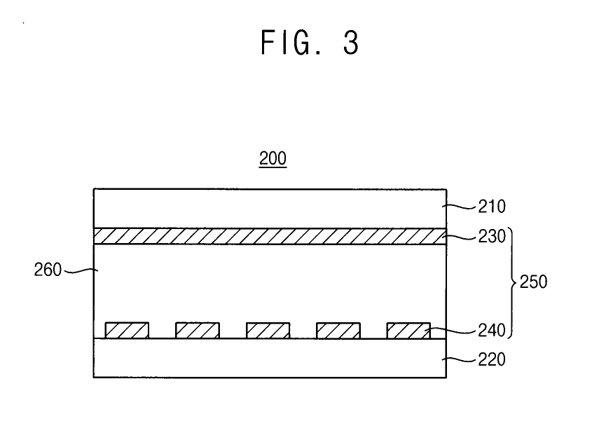

FIG. 2 is a three-dimensional depiction of a touch panel of a touch-input detection device included in a touch screen such as that of FIG. 1 according to one embodiment. FIG. 3 is a cross-sectional view of the touch panel of FIG. 2.

Referring to FIGS. 2 and 3, the touch panel 200 includes a pair of substrates (i.e., an upper substrate 210 and a lower substrate 220), an electro-rheological fluid 260 that is placed between the upper substrate 210 and the lower substrate 220, and a plurality of pairs of sensing electrodes 250 (i.e., a plurality of sensing electrodes 230 formed on the upper substrate 210 and a plurality of sensing electrodes 240 formed on the lower substrate 220).

The sensing electrodes 230 may be formed on the upper substrate 210 in a first direction. The sensing electrodes 240 may be formed on the lower substrate 220 in a second direction. For example, the first direction may be perpendicular to the second direction. In this case, the pairs of the sensing electrodes 250 may be arranged in a matrix form. That is, a plurality of capacitive nodes may be defined at a plurality of locations corresponding to a plurality of crossing points of the electrodes 230 formed on the upper substrate 210 and the electrodes 240 formed on the lower substrate 220.

As a touch-input is made on the upper substrate 210, a capacitance of the capacitive node located at a touch-input position may change (e.g., increase). Thus, it is determined that a touch-input of users has been made on the upper substrate 210 when the capacitance of the capacitive node located at the touch-input position reaches a predetermined threshold value.

Specifically, when a sensing signal SSGN is applied to the sensing electrodes 230 formed on the upper substrate 210, a voltage output from the sensing electrodes 240 formed on the lower substrate 220 may change based on the capacitance of the capacitive node. Accordingly, an output signal OSGN may be generated at the sensing electrodes 240 formed on the lower substrate 220, and then the output signal OSGN may be output to the touch sensing unit. Subsequently, the touch sensing unit may calculate the capacitance of the capacitive node by comparing the sensing signal SSGN with the output signal OSGN, and then may determine whether or not a touch-input of users has been made on the touch panel based on the comparison result. However, an operation of the touch-input detection device 100 is not limited thereto.

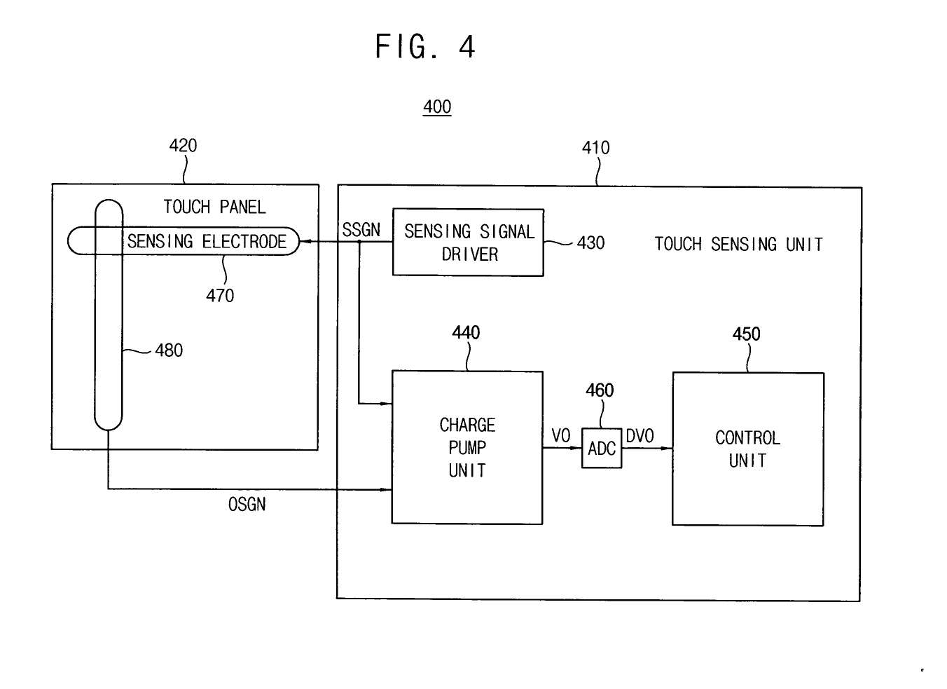

FIG. 4 is a block diagram illustrating a touch-input detection device according to example embodiments.

Referring to FIG. 4, the touch-input detection device 400 includes a touch sensing unit 410 and a touch panel 420. The touch sensing unit 410 includes a sensing signal driver 430, a charge pump unit 440, and a control unit 450. The touch panel 420 includes first sensing electrodes 470 and second sensing electrodes 480. In example embodiments, the touch sensing unit 410 further includes an analog-to-digital converter (ADC) 460.

The sensing signal driver 430 is configured to generate a sensing signal SSGN. The sensing signal SSGN may be applied to the charge pump unit 440 and the first sensing electrodes 470 of the touch panel 420. In example embodiments, the sensing signal SSGN may correspond to a square wave.

When the sensing signal SSGN is applied to the first sensing electrodes 470, a voltage output from the second sensing electrodes 480 may be detected based on a capacitance of a capacitive node. The capacitance corresponds to the capacitive node formed by the first sensing electrodes 470 and the second sensing electrodes 480. Thus, an output signal OSGN may be generated at the second sensing electrodes 480 by a level of the voltage determined by the capacitance.

The charge pump unit 440 is configured to receive the sensing signal SSGN from the sensing signal driver 430 and the output signal OSGN from the second sensing electrodes 480 of the touch panel 420, and is configured to generate an output voltage VO based on the sensing signal SSGN and the output signal OSGN. For example, the charge pump unit may generate the output voltage VO by comparing the sensing signal SSGN with the output signal OSGN. Here, the output voltage VO may depend on the capacitance of the capacitive node that is formed by the first sensing electrodes 470 and the second sensing electrodes 480.

The control unit 450 is configured to determine whether or not a touch-input of users has been made on the touch panel 420 based on an output voltage VO. In some example embodiments, the control unit 450 is configured to determine whether or not a touch-input of users has been made on the touch panel 420 based on a digitized output voltage DVO, where the digitized output voltage DVO is generated by digitizing the output voltage VO. The control unit 450 is configured to calculate the capacitance of the capacitive node using the output voltage VO or the digitized output voltage DVO. This is enabled by the fact that the output voltage VO and the digitized output voltage DVO include information related to the capacitance of the capacitive node formed by the first sensing electrodes 470 and the second sensing electrodes 480.

The analog-to-digital converter 460 is configured to receive the output voltage VO (i.e., an analog signal), and configured to output the digitized output voltage DVO (i.e., a digital signal). In other words, the analog-to-digital converter 460 is configured to convert the output voltage VO to the digitized output voltage DVO.

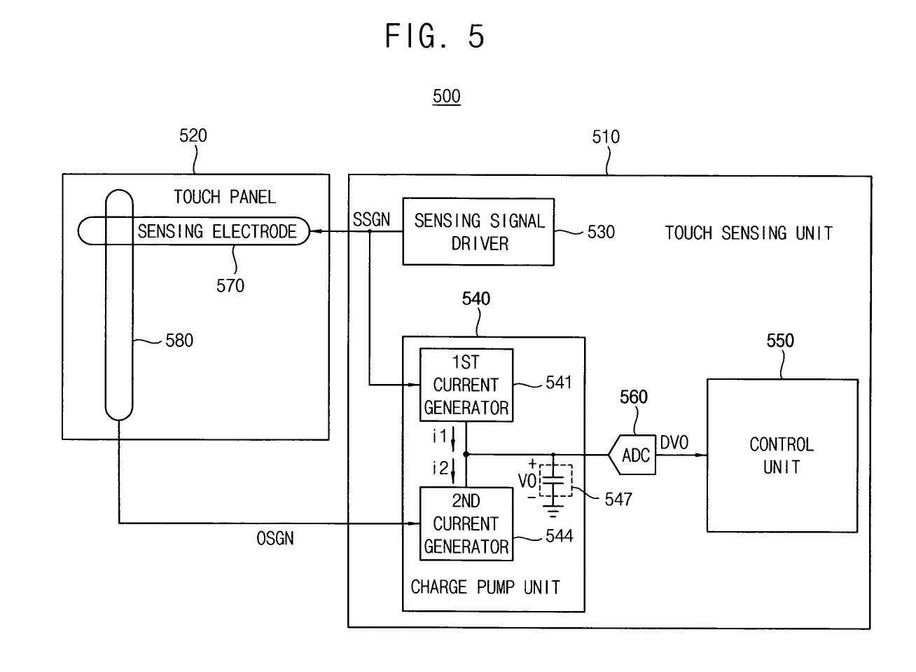

FIG. 5 is a block diagram illustrating one embodiment a touch input detection device.

Referring to FIG. 5, the touch-input detection device 500 includes a touch sensing unit 510 and a touch panel 520. The touch sensing unit 510 includes a sensing signal driver 530, a charge pump unit 540, and a control unit 550. The touch panel 520 includes first sensing electrodes 570 and second sensing electrodes 580. In example embodiments, the touch sensing unit 510 may further include an analog-to-digital converter 560.

Except for the charge pump unit 540, the touch-input detection device 500 is similar to the touch-input detection device 400 of FIG. 4.

The charge pump unit 540 includes a first current generator 541 configured to generate a first current i1 and a second current generator 544 configured to generate a second current i2. In example embodiments, the charge pump unit 540 further includes a capacitor 547 configured to store charge resulting from the first current i1 and the second current i2.

The first current generator 541 is configured to control the first current i1 that is generated based on a sensing signal SSGN output from the sensing signal driver 530.

The second current generator 544 is configured to control the second current i2 that is generated based on an output signal OSGN output from second sensing electrodes 580 of the touch panel 520.

The capacitor 547 is configured to store the charge resulting from the first current i1 and the second current i2. The stored charge generates an output voltage VO based on a voltage difference between first and second plates of the capacitor 547. In some example embodiments, the capacitor 547 may correspond to an element caused by parasitic capacitances of the charge pump unit 540, electric wiring, etc.

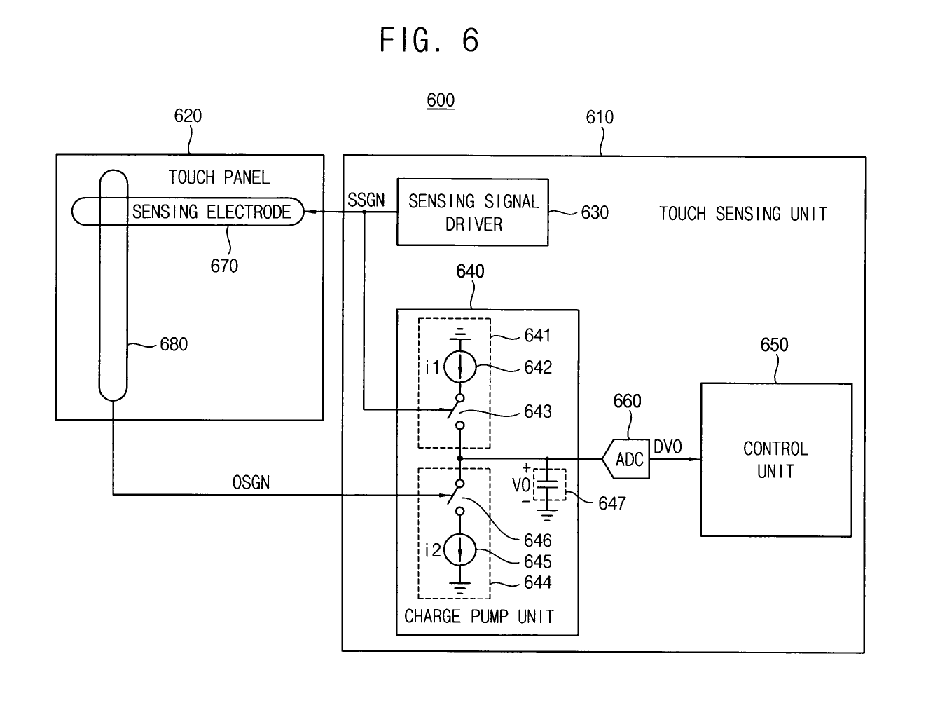

FIG. 6 is a block diagram illustrating another embodiment of a touch input detection device.

Referring to FIG. 6, the touch-input detection device 600 includes a touch sensing unit 610 and a touch panel 620. The touch sensing unit 610 includes a sensing signal driver 630, a charge pump unit 640, and a control unit 650. The touch panel 620 includes first sensing electrodes 670 and second sensing electrodes 680. In example embodiments, the touch sensing unit 610 further includes an analog-to-digital converter 660.

Except for the charge pump unit 640, the touch-input detection device 600 is similar to the touch-input detection device 500 of FIG. 5.

The charge pump unit 640 includes a first current generator 641 configured to generates a first current i1 and a second current generator 644 configured to generate a second current i2. In example embodiments, the charge pump unit 640 further includes a capacitor 647 configured to store charge resulting from the first current i1 and the second current i2.

The first current generator 641 is configured to control the first current i1 that is generated based on a sensing signal SSGN output from the sensing signal driver 630. Specifically, the first current generator 641 may include a first current source 642 and a first switch 643. The first current source 642 may generate the first current i1. The first switch 643 may be controlled by the sensing signal SSGN. The first switch 643 may turn-on when a voltage level of the sensing signal SSGN is greater than a predetermined voltage level, or when a voltage level of the sensing signal SSGN is smaller than a predetermined voltage level.

The second current generator 644 is configured to control the second current i2 that is generated based on an output signal OSGN output from the second sensing electrodes 680 of the touch panel 620. Specifically, the second current generator 644 may include a second current source 645 and a second switch 646. The second current source 645 may generate the second current i2. The second switch 646 may be controlled by the output signal OSGN. The second switch 646 may turn-on when a voltage level of the output signal OSGN is greater than a predetermined voltage level, or when a voltage level of the output signal OSGN is smaller than a predetermined voltage level.

The capacitor 647 is configured to store charge resulting from the first current i1 and the second current i2. The stored charge generates an output voltage VO by based on a voltage difference between first and second plates of the capacitor 647. In some example embodiments, the capacitor 647 may correspond to an element caused by parasitic capacitances of the charge pump unit 640, electric wiring, etc.

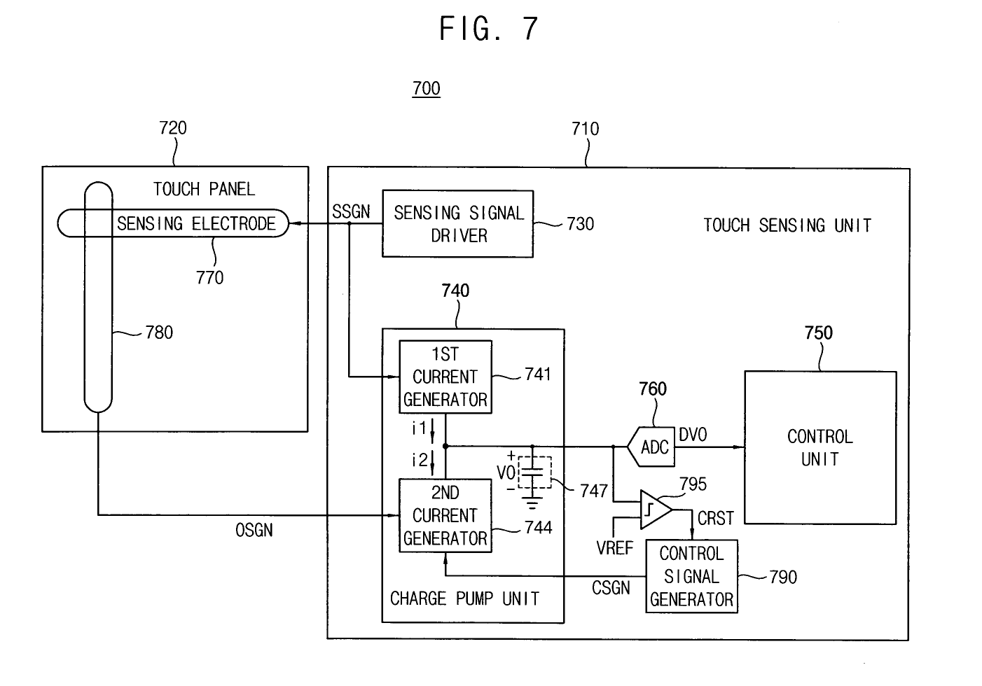

FIG. 7 is a block diagram illustrating still another embodiment of a touch input detection device.

Referring to FIG. 7, the touch-input detection device 700 includes a touch sensing unit 710 and a touch panel 720. The touch sensing unit 710 includes a sensing signal driver 730, a charge pump unit 740, a control unit 750, and a control signal generator 790. The touch panel 720 includes first sensing electrodes 770 and second sensing electrodes 780. In example embodiments, the touch sensing unit 710 further includes an analog-to-digital converter 760. In addition, the touch sensing unit 710 may further include a voltage comparator 795. In some example embodiments, the control signal generator 790 may include the voltage comparator 795.

Except for the voltage comparator 795, the control signal generator 790, and the charge pump unit 740, the touch-input detection device 700 is similar to the touch-input detection device 500 of FIG. 5.

The voltage comparator 795 is configured to compare an output voltage VO generated by the charge pump unit 740 with a predetermined reference voltage VREF, and may output a comparison result signal CRST to the control signal generator 790. Specifically, when the output voltage VO is not the same as the predetermined reference voltage VREF as the output voltage VO changes, the voltage comparator 795 may output the comparison result signal CRST having information that the output voltage VO is not the same as the predetermined reference voltage VREF to the control signal generator 790.

The control signal generator 790 is configured to receive the comparison result signal CRST from the voltage comparator 795, analyze the comparison result signal CRST, and generate a control signal CSGN to be output to the second current generator 744. Specifically, when the output voltage VO is not the same as the predetermined reference voltage VREF, the control signal generator 790 may control the second current i2 based on the control signal CSGN in order to control charges of the capacitor 747. As a result, the output voltage VO may be controlled to be the same as the predetermined reference voltage VREF. In some example embodiments, the control signal generator 790 is configured to compare the output voltage VO with the predetermined reference voltage VREF, and may generate the control signal CSGN to control the output voltage VO to be the same as the predetermined reference voltage VREF.

The second current generator 744 included in the charge pump unit 740 is configured to control the second current i2 based on the output signal OSGN output from the second sensing electrodes 780 of the touch panel 720 and the control signal CSGN output from the control signal generator 790. Thus, the output voltage VO may change because the charges of the capacitor 747 change as the second current i2 changes.

As described above, the touch-input detection device 700 is configured to control the second current i2 to eliminate or reduce parasitic capacitance components of the touch panel 720 that are generated without any touch-input of users. Therefore, the touch-input detection device 700 can have an improved operational performance due to an increase of a signal to noise ratio (SNR).

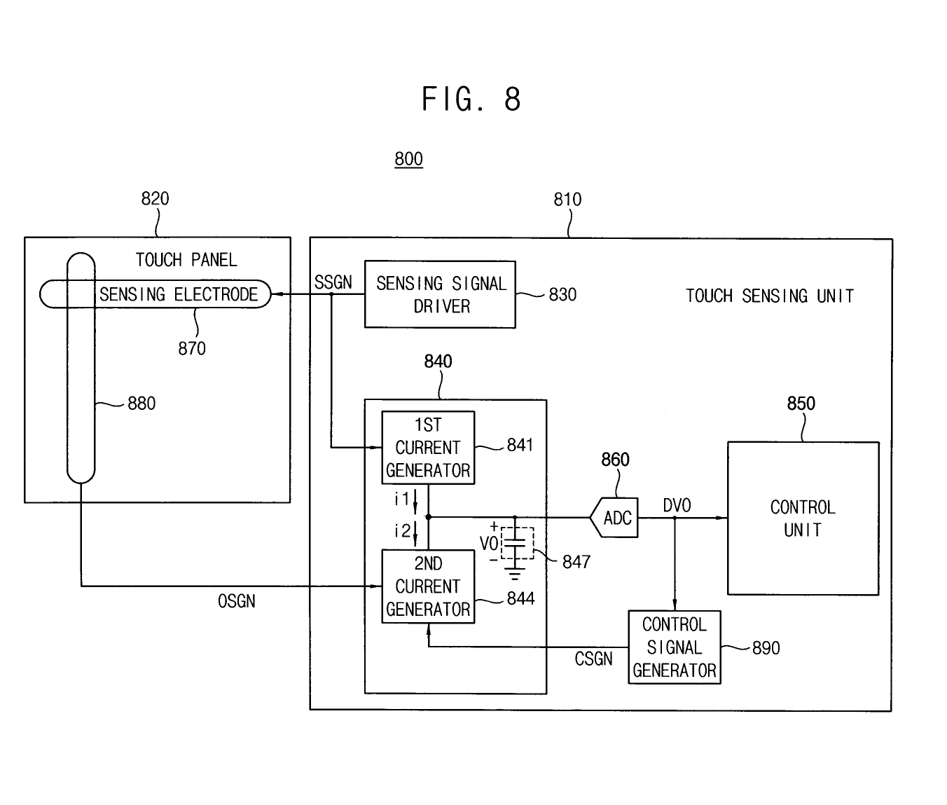

FIG. 8 is a block diagram illustrating still another embodiment of a touch input detection device.

Referring to FIG. 8, the touch-input detection device 800 includes a touch sensing unit 810 and a touch panel 820. The touch sensing unit 810 includes a sensing signal driver 830, a charge pump unit 840, a control unit 850, and a control signal generator 890. The touch panel 820 includes first sensing electrodes 870 and second sensing electrodes 880. In example embodiments, the touch sensing unit 810 further includes an analog-to-digital converter 860.

Except for the control signal generator 890 and the charge pump unit 840, the touch-input detection device 800 is similar to the touch-input detection device 500 of FIG. 5.

The control signal generator 890 is configured to receive and analyze a digitized output voltage DVO that is generated by digitizing an output voltage VO output from the charge pump unit 840, and generate a control signal CSGN to be output to the second current generator 844. Specifically, when the digitized output voltage DVO changes although no touch-input of users exists, the control signal generator 890 may control the second current i2 based on the control signal CSGN in order to control charges of the capacitor 847. As a result, the output voltage VO (or, the digitized output voltage DVO) may not be changed.

The second current generator 844 included in the charge pump unit 840 is configured to control the second current i2 based on the output signal OSGN output from the second sensing electrodes 880 of the touch panel 820 and the control signal CSGN output from the control signal generator 890. Thus, the output voltage VO may change because the charges of the capacitor 847 change as the second current i2 changes.

As described above, the touch-input detection device 800 is configured to control the second current i2 to eliminate or reduce parasitic capacitance components of the touch panel 820 that are generated without any touch-input of users. Therefore, the touch-input detection device 800 may have an improved operational performance due to an increase of an SNR.

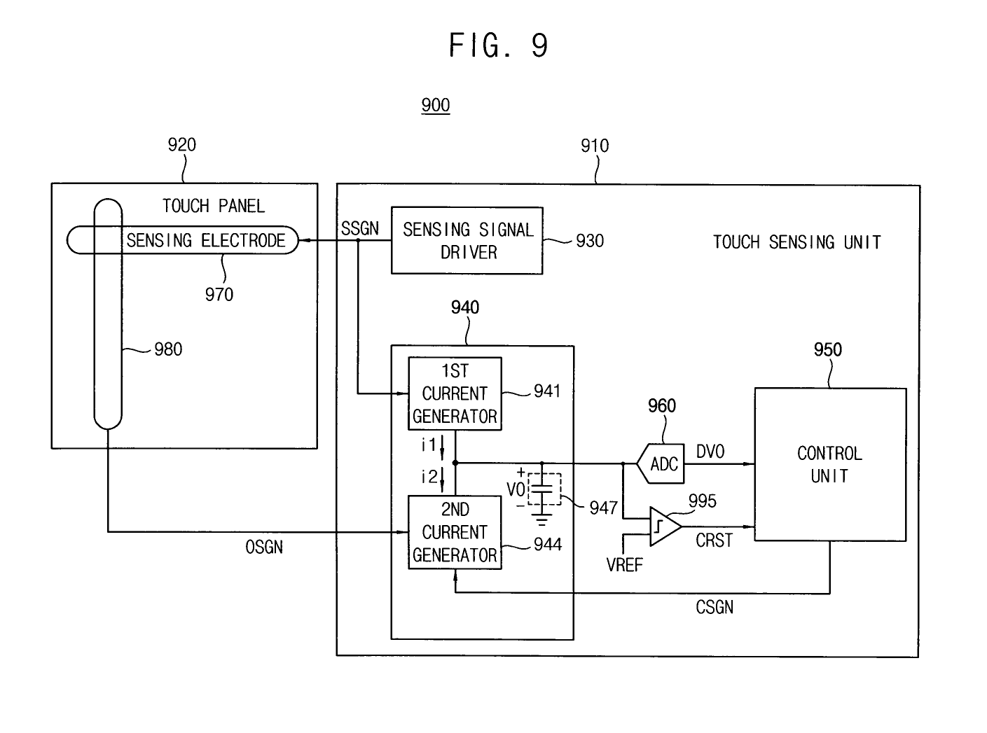

FIG. 9 is a block diagram illustrating still another example of a touch input detection device of FIG. 4.

Referring to FIG. 9, the touch-input detection device 900 includes a touch sensing unit 910 and a touch panel 920. The touch sensing unit 910 includes a sensing signal driver 930, a charge pump unit 940, and a control unit 950. The touch panel 920 includes first sensing electrodes 970 and second sensing electrodes 980. In example embodiments, the touch sensing unit 910 further includes an analog-to-digital converter 960. In addition, the touch sensing unit 910 further includes a voltage comparator 995. In some example embodiments, the control unit 950 includes the voltage comparator 995.

Except for the voltage comparator 995, the control unit 950, and the charge pump unit 940, the touch-input detection device 900 is similar to the touch-input detection device 500 of FIG. 5.

The voltage comparator 995 is configured to compare an output voltage VO generated by the charge pump unit 940 with a predetermined reference voltage VREF, and may output a comparison result signal CRST to the control unit 950. Specifically, when the output voltage VO is not the same as the predetermined reference voltage VREF as the output voltage VO changes, the voltage comparator 995 may output the comparison result signal CRST having information that the output voltage VO is not the same as the predetermined reference voltage VREF to the control unit 950.

The control unit 950 is configured to receive the comparison result signal CRST from the voltage comparator 995, analyze the comparison result signal CRST, and generate a control signal CSGN to be output to the second current generator 944. Specifically, when the output voltage VO is not the same as the predetermined reference voltage VREF, the control unit 950 may control the second current i2 based on the control signal CSGN in order to control charges of the capacitor 947. As a result, the output voltage VO may be controlled to be the same as the predetermined reference voltage VREF. In some example embodiments, the control unit 950 may compare the output voltage VO with the predetermined reference voltage VREF, and may generate the control signal CSGN to control the output voltage VO to be the same as the predetermined reference voltage VREF.

The second current generator 944 included in the charge pump unit 940 is configured to control the second current i2 based on the output signal OSGN output from the second sensing electrodes 980 of the touch panel 920 and the control signal CSGN output from the control unit 950. Thus, the output voltage VO may change because the charges of the capacitor 947 change as the second current i2 changes.

As described above, the touch-input detection device 900 may control the second current i2 to eliminate or reduce parasitic capacitance components of the touch panel 920 that are generated without any touch-input of users. Therefore, the touch-input detection device 900 may have an improved operational performance due to an increase of an SNR.

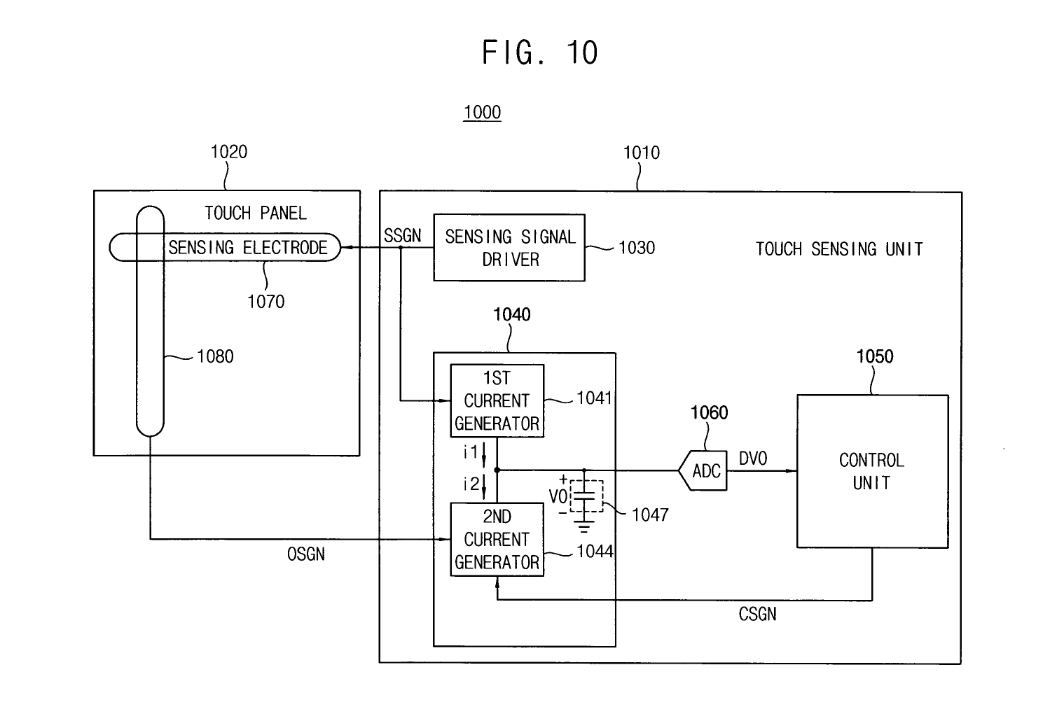

FIG. 10 is a block diagram illustrating another embodiment of a touch input detection device.

Referring to FIG. 10, the touch-input detection device 1000 includes a touch sensing unit 1010 and a touch panel 1020. The touch sensing unit 1010 includes a sensing signal driver 1030, a charge pump unit 1040, and a control unit 1050. The touch panel 1020 includes first sensing electrodes 1070 and second sensing electrodes 1080. In example embodiments, the touch sensing unit 1010 further includes an analog-to-digital converter 1060.

Except for the control unit 1050 and the charge pump unit 1040, the touch-input detection device 1000 is similar to the touch-input detection device 500 of FIG. 5.

The control unit 1050 is configured to receive and analyze a digitized output voltage DVO that is generated by digitizing an output voltage VO output from the charge pump unit 1040, and generate a control signal CSGN to be output to the second current generator 1044. Specifically, when the digitized output voltage DVO changes although no touch-input of users exists, the control unit 1050 may control the second current i2 based on the control signal CSGN in order to control charges of the capacitor 1047. As a result, the output voltage VO (or, the digitized output voltage DVO) may not be changed.

The second current generator 1044 included in the charge pump unit 1040 is configured to control the second current i2 based on the output signal OSGN output from the second sensing electrodes 1080 of the touch panel 1020 and the control signal CSGN output from the control unit 1050. Thus, the output voltage VO may change because the charges of the capacitor 1047 change as the second current i2 changes.

As described above, the touch-input detection device 1000 may control the second current i2 to eliminate or reduce parasitic capacitive components of the touch panel 1020 that are generated without any touch-input of users. Therefore, the touch-input detection device 1000 may have an improved operational performance due to an increase of an SNR.

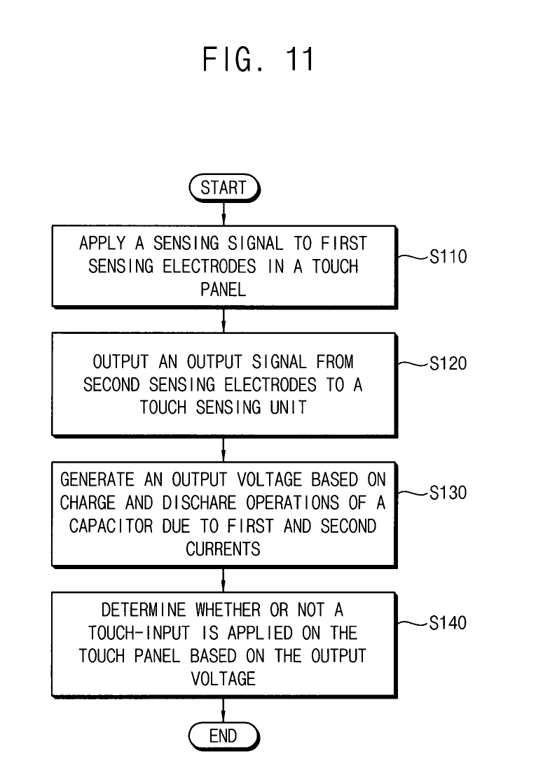

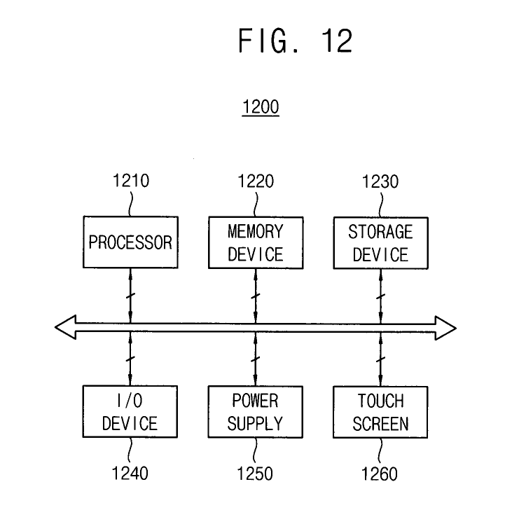

FIG. 11 is a flow chart illustrating a method of detecting a touch-input according to example embodiments.

Referring to FIG. 11, the method includes applying S110 a sensing signal to first sensing electrodes in a touch panel. Here, the sensing signal may be generated by a sensing signal driver of a touch sensing unit. As the sensing signal is applied to the first sensing electrodes, a voltage level of second sensing electrodes may change based on a capacitance of a capacitive node. Here, the capacitive node may correspond to a pair of sensing electrodes (i.e., a first sensing electrode and a second sensing electrode). That is, the first sensing electrodes and the second sensing electrodes may form a plurality of capacitive nodes in the touch panel. Thus, the method of FIG. 11 includes outputting S120 an output signal from the second sensing electrodes to the touch sensing unit.

As described above, the sensing signal controls a first current, and the output signal controls a second current. A capacitor may perform charge and discharge operations using the first current and the second current. Thus, the method of FIG. 11 includes generating S130 an output voltage based on the charge and discharge operations of the capacitor using the first current and the second current.

Subsequently, the method of FIG. 11 includes determining S140 whether or not a touch input of users has been made on the touch panel based on the output voltage. For example, a control unit may determine whether or not the touch-input of users has been made on the touch panel based on the output voltage. Since the control unit can detect a capacitance change of the touch panel (i.e., the capacitive node) by analyzing the output voltage, the control unit may determine whether or not the touch-input of users has been made on the touch panel by detecting the capacitance-change of the touch panel (i.e., the capacitive node) that is caused by the touch-input of users.

FIG. 12 is a block diagram illustrating an electronic device having a touch screen according to example embodiments.

Referring to FIG. 12, the electronic device 1200 includes a processor 1210, a memory device 1220, a storage device 1230, an input/output (I/O) device 1240, a power supply 1250, and a touch screen 1260. Here, the touch screen 1260 includes the touch-input detection device 100 of FIG. 1. In addition, the electronic device 1200 may further include a plurality of ports for communicating a video card, a sound card, a memory card, a universal serial bus (USB) device, other electronic devices, etc.

The processor 1210 may perform various computing functions. The processor 1210 may be a microprocessor, a central processing unit (CPU), etc. The processor 1210 may be coupled to other components via an address bus, a control bus, a data bus, etc. Further, the processor 1210 may be coupled to an extended bus such as a peripheral component interconnection (PCI) bus. The memory device 1220 may store data for operations of the electronic device 1200. For example, the memory device 1220 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device, a mobile dynamic random access memory (mobile DRAM) device, etc. The storage device 1230 may be a solid state drive (SSD) device, a hard disk drive (HDD) device, a CD-ROM device, etc. The I/O device 1240 may be an input device such as a keyboard, a keypad, a touchpad, a mouse, etc., and an output device such as a printer, a speaker, etc. In some example embodiments, the touch screen 1260 may be included in the I/O device 1240. The power supply 1250 may provide a power for operations of the electronic device 1200.

The touch screen 1260 having touch-input detection device 100 of FIG. 1 may have an improved operational performance because the touch-input detection device 100 of FIG. 1 eliminates (i.e., reduces) parasitic components of a touch panel by simply controlling currents generated in a charge pump unit (i.e., with a simple structure). That is, the touch-input detection device 100 of FIG. 1 may detect a capacitance-change of the touch panel based on a change of an output voltage due to a difference between the currents generated in the charge pump unit.

The present inventive concept may be applied to an electronic device having a touch screen. For example, the present inventive concept may be applied to a television, a computer monitor, a laptop, a digital camera, a cellular phone, a smart phone, a smart pad, a personal digital assistant (PDA), a portable multimedia player (PMP), an MP3 player, a video phone, a game console, a navigation system, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A touch input detection device comprising:
a touch panel having first sensing electrodes and second sensing electrodes;
a sensing signal driver configured to generate a sensing signal and apply the sensing signal to a charge pump unit and the first sensing electrodes;
the charge pump unit configured to generate an output voltage based on the sensing signal and an output signal from the second sensing electrodes; and
a control unit configured to determine whether or not a touch input has been made on the touch panel based on the output voltage.

2. The device of claim 1, further comprising:
an analog-to-digital converter configured to digitize the output voltage into a digitized output voltage,
wherein the control unit is configured to determine whether or not the touch input has been made on the touch panel based on the digitized output voltage.

3. The device of claim 1, wherein the sensing signal comprises a square wave.

4. The device of claim 1, wherein the control unit is configured to determine a touch-input position on the touch panel based on the output voltage.

5. The device of claim 1, wherein the charge pump unit includes:
a first current generator configured to generate a first current based on the sensing signal; and
a second current generator configured to generate a second current based on the output signal,
wherein a change in the output voltage corresponds to a difference between the first current and the second current.

6. The device of claim 5, wherein the charge pump unit further includes:
a capacitor configured to be charged and discharged using the first current and the second current, and
wherein the change in the output voltage depends on a change in the amount of charge stored in the capacitor resulting from the difference between the first current and the second current.

7. The device of claim 5, wherein the first current generator includes a first current source and a first switch, the first switch being controlled by the sensing signal.

8. The device of claim 5, wherein the second current generator includes a second current source and a second switch, the second switch being controlled by the output signal.

9. The device of claim 5, wherein the control unit generates a control signal to be output to the second current generator, and
wherein the second current generator controls the second current based on the output signal and the control signal.

10. The device of claim 5, further comprising:
a control signal generator configured to generate a control signal to be output to the second current generator,
wherein the second current generator controls the second current based on the output signal and the control signal.

11. The device of claim 10, wherein the control signal generator is configured to generate the control signal based on a digitized output voltage converted from the output voltage by an analog-to-digital converter.

12. The device of claim 10, further comprising:
a voltage comparator configured to output a comparison result signal by comparing the output voltage with a predetermined reference voltage,
wherein the control signal generator generates the control signal based on the comparison result signal.

13. A touch screen comprising:
a display device; and
a touch input detection device configured to detect a touch input, comprising:
a touch panel having first sensing electrodes and second sensing electrodes;
a sensing signal driver configured to generate a sensing signal and apply the sensing signal to a charge pump unit and the first sensing electrodes;
the charge pump unit configured to generate an output voltage based on the sensing signal and an output signal from the second sensing electrodes; and
a control unit configured to determine whether or not a touch input has been made on the touch panel based on the output voltage.

14. The touch screen of claim 13, wherein the charge pump unit includes:
a first current generator configured to generate a first current based on the sensing signal; and
a second current generator configured to generate a second current based on the output signal, and
wherein a change in the output voltage corresponds to a difference between the first current and the second current.

15. A method of detecting a touch-input comprising:
applying a sensing signal to first sensing electrodes in a touch panel;
outputting an output signal from second sensing electrodes to a touch sensing unit, the first sensing electrodes and the second sensing electrodes forming a plurality of capacitive nodes in the touch panel;
generating an output voltage based on a stored charge in a capacitor, the stored charge resulting from a first current generated based on the sensing signal and a second current generated based the output signal; and
determining whether or not a touch input has been made on the touch panel based on the output voltage.

16. The method of claim 15, wherein the sensing signal corresponds to a square wave.

17. The method of claim 15, wherein determining whether or not the touch input has been made on the touch panel includes:
converting the output voltage into a digitized output voltage using an analog-to-digital converter.

18. The method of claim 15, wherein determining whether or not the touch input has been made on the touch panel includes:
outputting a comparison result signal by comparing the output voltage against a predetermined reference voltage; and
controlling the second current based on the comparison result signal.

19. The method of claim 15, wherein determining whether or not the touch input has been made on the touch panel includes:
controlling the second current based on a digitized output voltage, wherein the digitized output voltage is converted from the output voltage using an analog-to-digital converter.

20. The method of claim 15, wherein determining whether or not the touch input has been made on the touch panel includes:
determining a touch input position on the touch panel based on the output voltage.
